(19) United States
(12) Patent Application Publication
(10) Pub. No.: US 2019/0043359 A1
(43) Pub. Date: Feb. 7, 2019

(54) SENSOR-EQUIPPED TRAFFIC SAFETY MESSAGE SYSTEMS AND RELATED METHODS

(71) Applicant: Laird Technologies, Inc., Earth City, MO (US)

(72) Inventor: Balachander Rajakondala, Holly, MI (US)

(21) Appl. No.: 15/667,885

(22) Filed: Aug. 3, 2017

(51) Int. Cl. G08G 1/16; G08G 1/01; G08G 1/017; G08G 1/04; G08G 1/052; G08G 1/0967; H04W 4/00

(52) U.S. Cl. CPC G08G 1/163; G08G 1/0116; G08G 1/0125; G08G 1/0141; H04W 4/008; G08G 1/04; G08G 1/052; G08G 1/096783; G08G 1/166; G08G 1/0175

(57) ABSTRACT

According to various aspects, exemplary embodiments are disclosed of sensor-equipped traffic safety message systems and related methods. In an exemplary embodiment, a traffic safety node generally includes a dedicated short-range communications (DSRC) interface for communication with other traffic safety nodes. One or more sensors of the traffic safety node are configured to detect objects in motion. A processor and memory of the traffic safety node are configured to determine a trajectory of a moving object based on input from the sensor(s), and based at least in part on the trajectory, to broadcast via the DSRC interface a traffic safety message regarding the moving object.

### FIELD

The present disclosure generally relates to sensor-equipped traffic safety message systems and related methods.

### BACKGROUND

This section provides background information related to the present disclosure which is not necessarily prior art.

Intersection movement assist (IMA) is a network technology that may be used to warn a vehicle driver if it is not safe to enter a traffic intersection, e.g., if another vehicle is making a sudden turn or is running a red light. Dedicated short-range communications (DSRC), which are short- to medium-range wireless communications at very high rates of data transmission, can be used in IMA networking to help prevent collisions in traffic intersections.

### SUMMARY

This section provides a general summary of the disclosure, and is not a comprehensive disclosure of its full scope or all of its features.

According to various aspects, exemplary embodiments are disclosed of sensor-equipped traffic safety message systems and related methods. In an exemplary embodiment, a traffic safety node generally includes a dedicated short-range communications (DSRC) interface for communication with other traffic safety nodes. One or more sensors of the traffic safety node are configured to detect objects in motion. A processor and memory of the traffic safety node are configured to determine a trajectory of a moving object based on input from the sensor(s), and based at least in part on the trajectory, to broadcast via the DSRC interface a traffic safety message regarding the moving object.

In another exemplary embodiment, a traffic safety node generally includes a dedicated short-range communications (DSRC) interface for broadcasting traffic safety messages and for receiving traffic safety messages from DSRC-equipped vehicles. One or more sensors of the traffic safety node are configured to detect objects in motion. The traffic safety node also includes a processor and memory configured to use input from the sensor(s) to determine a trajectory and speed of a moving object and to determine whether the moving object is a vehicle. The node is further configured to transmit a traffic safety message as to the moving object via the DSRC interface, if the moving object is determined to be a vehicle.

Also disclosed are exemplary embodiments of methods relating to sensor-equipped traffic safety message systems. In one example method of performing intersection movement assist (IMA), a traffic safety node receives, via a DSRC interface, data from one or more DSRC-equipped vehicles. The traffic safety node uses one or more sensors to detect an object in motion. Based on the data received from the DSRC-equipped vehicle(s), the traffic safety node determines whether the detected object in motion is one of the DSRC-equipped vehicle(s). Based on the determining, the traffic safety node adds the detected object in motion to a list of moving vehicles that includes DSRC equipped vehicle(s). The traffic safety node broadcasts, via the DSRC interface, one or more traffic safety messages regarding the moving vehicles including the detected object in motion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a conceptual diagram of a sensor-equipped traffic safety node according to an exemplary embodiment;

FIG. 2 is a conceptual illustration of traffic intersections in which traffic safety nodes are provided according to an exemplary embodiment;

FIG. 3 is a flow diagram of a method of performing intersection movement assist (IMA) according to an exemplary embodiment; and

FIG. 4 is a flow diagram of a method of using sensor data to determine a trajectory of a moving object according to an exemplary embodiment.

### DETAILED DESCRIPTION

Example embodiments will now be described more fully with reference to the accompanying drawings.

The inventor has recognized that DSRC-based IMA applications have been developed in which each vehicle would be DSRC-equipped and would periodically transmit its location, speed, and heading. Each DSRC-equipped vehicle receiving the transmissions would be made aware of the trajectories of the other DSRC-equipped vehicles. In such a system, all of the vehicles' trajectories could be used to calculate possible collisions and give warnings/alerts to drivers to help avoid possible collisions. But the inventor has further realized that although DSRC-based IMA systems would be highly effective if all vehicles approaching intersections were DSRC-capable, it is likely that an IMA system would not be fully dependable with respect to non-DSRC-capable vehicles approaching intersections. In such cases, an IMA system typically would not be able to predict the trajectories of vehicles that are not DSRC-capable. Such vehicles are likely to be older cars, trucks, etc., produced prior to the introduction of DSRC-equipped vehicles.

Accordingly, the inventor has developed and hereby discloses various exemplary embodiments of sensor-equipped traffic safety message systems and related methods. In one example embodiment, a sensor-equipped traffic safety node includes a dedicated short-range communications (DSRC) interface configured for communication with other DSRC-equipped traffic safety nodes, e.g., provided in vehicles and/or infrastructure. The sensor-equipped traffic safety node also includes one or more sensors configured to detect objects in motion. A processor and memory of the sensor-equipped traffic safety node are configured to determine a trajectory of a moving object based on input from the sensor(s). Based at least in part on the trajectory, the sensor-equipped traffic safety node uses the DSRC interface to broadcast a traffic safety message regarding the moving object. Unless indicated otherwise herein, the term “trajectory” is used to refer to a path described by an object moving through space. Data such as location, direction of movement, and/or speed of a moving object may be used to determine a trajectory of the moving object.

It should be noted that various types of traffic safety nodes discussed herein may be provided in various fixed locations or on mobile hosts. Thus, e.g., infrastructure, vehicles, smartphones or other mobile devices, etc., may be provided with various types of traffic safety nodes. Some traffic safety nodes discussed herein (e.g., traffic safety nodes provided in various motor vehicles) would not necessarily be configured to use sensors to detect moving objects. In various embodiments of the disclosure, however, where such nodes are equipped with DSRC interfaces, such nodes could receive and re-broadcast traffic safety messages from sensor-equipped traffic safety nodes. Thus, e.g., a sensor-equipped traffic safety node provided at a traffic intersection could detect a non-DSRC-equipped vehicle in moving traffic and could broadcast an alert to DSRC-equipped vehicles, which could re-broadcast the alert to other DSRC-equipped vehicles moving in traffic.

In some planned applications for DSRC-capable vehicle-to-infrastructure (V2I), systems could be used to observe oncoming traffic and broadcast signals, warnings and/or alerts received from DSRC-capable traffic to vehicles in the vicinity that are DSRC-capable. In various implementations of the present disclosure, V2I systems may be equipped with additional sensors, such as radar, LIDAR (light detection and ranging), ultrasonic sensors, cameras, etc. In various implementations of the disclosure, and using such sensors, V2I system embodiments can perform object detection and object classification. When objects are detected and have been selected as particular objects that are moving, a given moving object may be identified as a vehicle. Dependent at least in part on the type(s) of sensor(s) provided on a given traffic safety node, the node could identify a moving object as a vehicle through use of various methods, including but not limited to recognizing shape, speed, size, and/or location of the moving object, etc.

Data as to a moving object may be compared with data being received from vehicles that are DSRC-capable. Moving objects that do not match vehicles identified through DSRC technology could possibly be vehicles that are not DSRC-capable. In various implementations of the disclosure, V2I systems may broadcast speeds, heading, and locations of moving vehicles that are being monitored, e.g., by a sensor-equipped node. Such monitoring may include not only DSRC-capable vehicles but also moving objects that have been identified as possible vehicles that are not DSRC-capable. In various implementations of the disclosure, every DSRC-capable vehicle in a given vicinity may be made aware of all vehicles around a given intersection. Furthermore, in various implementations, IMA applications provided on DSRC-capable vehicles may be configured to receive and utilize such data and may be used to generate IMA alerts.

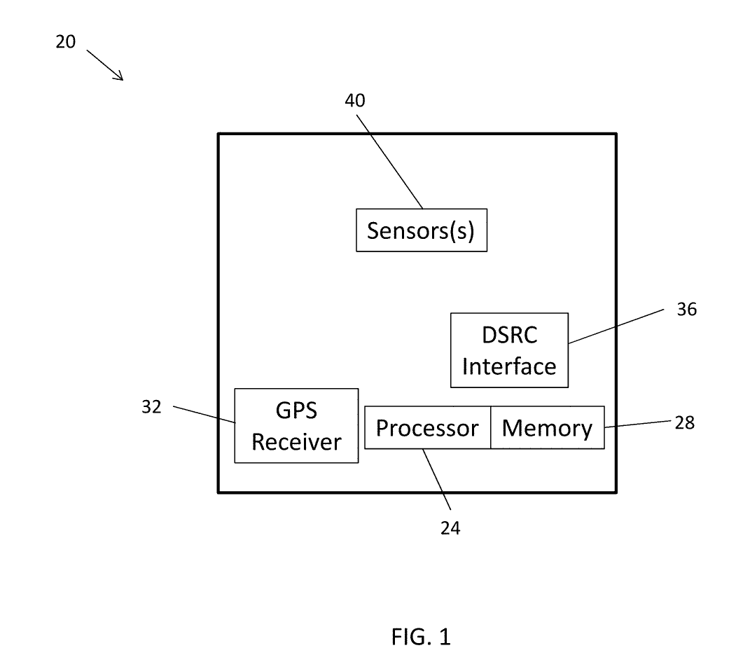

One example embodiment of a sensor-equipped traffic safety node is indicated generally in FIG. 1 by reference number 20. The sensor-equipped node 20 may be provided as a stationary node, e.g., in or on traffic signals, signs, buildings, roadside installations, other infrastructure, etc. However, in various embodiments, a mobile sensor-equipped traffic safety node may be provided. The example sensor-equipped node 20 includes a processor 24 and memory 28, and a GPS receiver 32 and/or other locating means. In some stationary traffic safety node embodiments, an absolute geographic location of an installed traffic safety node may be determined and stored, e.g., in the memory 28, for future use as further described below. In this example, the receiver 32 is a GPS (Global Positioning System) receiver. Other exemplary embodiments may include receivers configured for use with other Global Navigation Satellite System (GNSS) signals or frequencies, such as BeiDou Navigation Satellite System (BDS), the Russian Global Navigation Satellite System (GLONASS), other satellite navigation system frequencies, etc.

A DSRC interface 36 of the node 20 is configured to send and receive DSRC messages. The node 20 also includes one or more sensors 40, which may include (without limitation) one or more of the following: camera(s), radar system(s), light detection and ranging (LIDAR) system(s), ultrasonic sensor(s), etc. It should be noted that various types and/or numbers of sensors could be used in various traffic safety node embodiments, dependent, e.g., on traffic safety node location, expected types, and/or density of traffic, environmental conditions, etc.

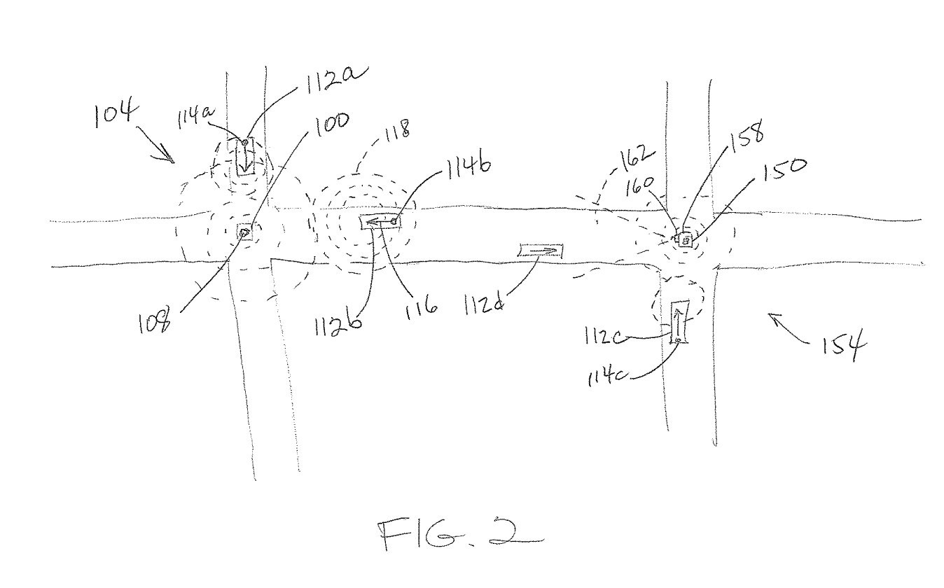

Various embodiments of traffic safety nodes may be provided, for example, as shown in FIG. 2. A traffic light 100 at a first street intersection 104 includes a DSRC-equipped infrastructure traffic safety node 108, which may or may not be sensor-equipped. Two vehicles 112a and 112b are provided respectively with DSRC-equipped traffic safety nodes 114a and 114b. As indicated by directional arrows 116, both vehicles 112a, 112b are moving toward the traffic light 100. Each vehicle traffic safety node 114a and 114b periodically broadcasts DSRC messages. The messages include data such as location, speed, acceleration, direction of movement, etc. of the vehicle 112a or 112b that includes the corresponding traffic safety node 114a or 114b. Thus, for example, if the traffic safety node 114a of the vehicle 112a comes within broadcast range of the traffic safety node 114b of the other vehicle, the traffic safety node 114a of the vehicle 112a may receive DSRC messages from the traffic safety node 114b. Where, for example, the traffic safety node 114a is capable of determining the trajectory of the vehicle 112b based on the messages broadcast by the traffic safety node 114b, the traffic safety node 114a of the vehicle 112a may alert the driver(s) of the vehicle(s) 112a and/or 112b, e.g., if the vehicles are approaching a possible collision. However, in the example situation shown in FIG. 2, the vehicles 112a and 112b are not yet close enough together to communicate directly with each other by DSRC.

Infrastructure traffic safety nodes such as the traffic light node 108 can provide additional assistance to DSRC-equipped vehicles approaching intersections. For example, as the vehicle 112b comes within DSRC reception range of the traffic safety node 108 of the traffic light 100, the traffic safety node 108 receives the periodic DSRC broadcasts from the vehicle 112b and may periodically re-broadcast DSRC messages providing data such as location, speed, acceleration, direction of movement, etc. of the approaching vehicle 112b. As the vehicle 112a comes within DSRC reception range of the traffic safety node 108, the vehicle 112a may receive, from the traffic safety node 108, DSRC messages regarding location and movement of the vehicle 112b.

The traffic light node 108 may be further capable of determining trajectories of both vehicles 112a, 112b and determining whether a collision of the vehicles 112a, 112b may be imminent. In the present example, although the vehicle 112a has not yet reached a broadcast range 118 of the DSRC transmissions of the vehicle 112b, the traffic light node 108 can provide each vehicle 112a, 112b with information as to movement by the other vehicle. The traffic light node 108 tracks the movement of both vehicles 112a, 112b and may broadcast a DSRC alert, for example, if the traffic light node 108 determines that the vehicle 112a is traveling so fast that it could run a red light at the intersection 104 and collide with the vehicle 112b.

In various embodiments of the disclosure, infrastructure traffic safety nodes that are sensor-equipped can assist DSRC-equipped vehicles, e.g., by broadcasting alerts regarding vehicles that are not DSRC-equipped. For example, a traffic light 150 at a second street intersection 154 is provided with a DSRC- and sensor-equipped traffic safety node 158. The node 158 includes a camera 160 having a range 162 (indicated by dashed lines) and configured to provide image data for traffic moving toward the second street intersection 154 from the direction of the first street intersection 104.

A vehicle 112c is provided with a DSRC-equipped traffic safety node 114c that periodically broadcasts DSRC messages. The messages include data such as location, speed, acceleration, direction of movement, etc. of the vehicle 112c. At the second intersection 154, the sensor-equipped traffic safety node 158 of the traffic light 150 receives the periodic DSRC broadcasts from the vehicle 112c and periodically broadcasts DSRC messages describing the current locations, speeds, directions of movement, trajectories, accelerations, etc. of the vehicle 112c.

A vehicle 112d, however, is not equipped with a traffic safety node and cannot transmit or receive DSRC messages. As the DSRC-unequipped vehicle 112d approaches the traffic light 150 and comes to within camera range 162 of the traffic light node 158, the traffic light node 158 uses periodic input from the camera 160 to determine locations, speeds, directions of movement, accelerations, etc. for the DSRC-unequipped vehicle 112d. The traffic light node 158 may use the camera input to determine a trajectory of the DSRC-unequipped vehicle 112d. In the present example embodiment, the traffic light node 158 broadcasts periodic DSRC messages whereby the DSRC-equipped vehicle 112c is provided with information as to movement by the DSRC-unequipped vehicle 112d. The traffic safety node 158 at the traffic light 150 tracks the movement of both vehicles 112c, 112d and may broadcast an alert if, for example, the traffic light node 158 determines that the DSRC-unequipped vehicle 112d is traveling such that it could run a red light at the second intersection 154 and collide with the DSRC-equipped vehicle 112c. In various implementations, the DSRC-equipped vehicle 112c may re-broadcast alerts received from the traffic light node 158. Other DSRC-equipped vehicles thus may be alerted not only as to various DSRC-equipped vehicles, but also as to the presence and movement of the DSRC-unequipped vehicle 112d.

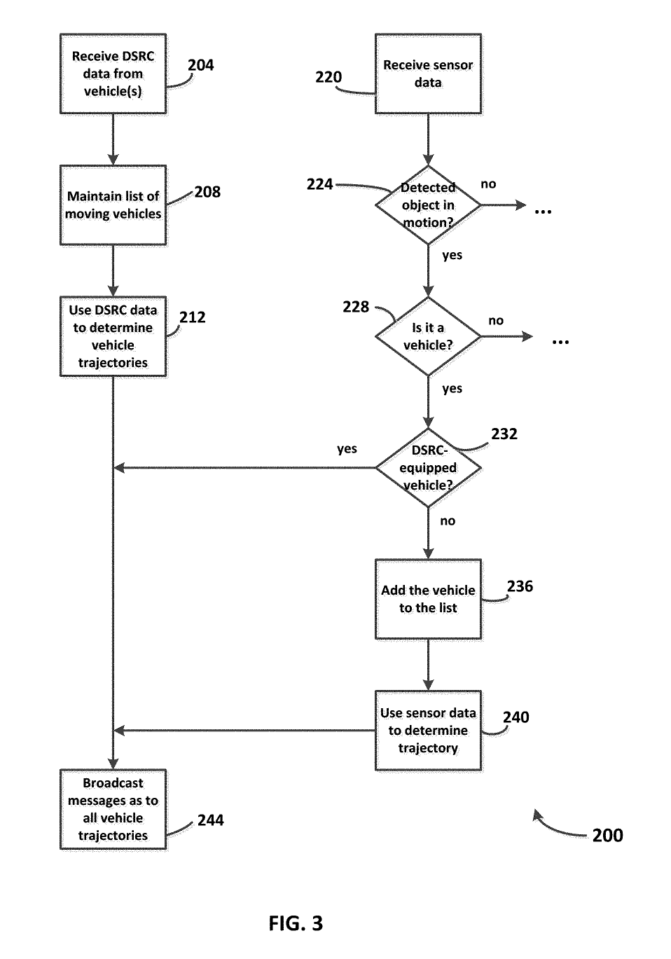

Also disclosed are exemplary embodiments of methods relating, e.g., to IMA. An example method of performing IMA is indicated generally in FIG. 3 by reference number 200. In process 204, an infrastructure traffic safety node periodically receives, via a DSRC interface of the node, data from one or more moving DSRC-equipped vehicles. The data includes such information as location, direction of movement, and speed of each of the DSRC-equipped vehicle(s). In process 208, the infrastructure traffic safety node maintains a list of moving vehicles that includes each of the DSRC-equipped vehicles from which the infrastructure traffic safety node receives data via DSRC. In process 212, the node uses the DSRC data to determine a trajectory of each of the DSRC-equipped vehicles.

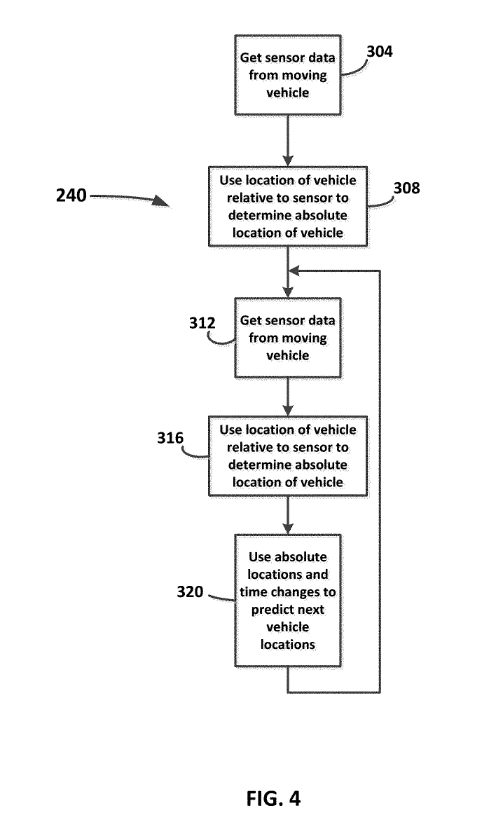

Additionally or alternatively, in process 220, the infrastructure traffic safety node periodically receives sensor data from one or more sensors of the node. In process 224, the node uses the sensor data to detect an object in motion. In process 228, the node determines whether the detected object is a vehicle. If yes, then in process 232, the node determines whether the detected object is one of the DSRC-equipped vehicle(s) from which the node is receiving DSRC communications and that is already on the list of moving vehicles. If the infrastructure traffic safety node determines that the detected object in motion is not one of the DSRC-equipped vehicle(s), then in process 236, the infrastructure traffic safety node adds the detected object to the list of moving vehicle(s). In process 240 and as further described below with reference to FIG. 4, the infrastructure traffic safety node uses the sensor data to determine a trajectory of the detected object in motion. Data received from the sensor(s) may be used, e.g., to determine location, direction of movement, and speed of the detected object.

In process 244, the infrastructure traffic safety node uses the trajectory information for sensor-detected vehicle(s) as well as the trajectory information for DSRC-equipped vehicle(s) to monitor movement of all of the vehicles on the list. The node may broadcast alerts of possible collisions and/or other traffic safety message(s) to the DSRC-equipped vehicles regarding all of the moving vehicle(s), including the DSRC-unequipped vehicle(s), in the list. DSRC-equipped vehicles may then re-broadcast traffic safety messages received from the infrastructure traffic safety node, regarding vehicle(s) that are DSRC-equipped and also messages regarding vehicle(s) that are not DSRC-equipped.

Although FIGS. 3 and 4 describe the method 200 as a sequential flow for explanatory purposes, it shall be understood that various processes shown in FIGS. 3 and 4 may be performed substantially in parallel, repetitively, and/or in sequences other than as shown in FIGS. 3 and/or 4. Thus, e.g., an infrastructure traffic safety node may receive DSRC data and/or sensor data, may identify moving vehicles, may determine vehicle trajectories, and/or may broadcast DSRC alerts and/or other traffic safety messages in such sequences and at such frequencies and transmission rates so as to make such processes appear in real time to be substantially continuous and/or performed in parallel.

The process 240 may be performed, e.g., as shown in FIG. 4. In process 304, the infrastructure traffic safety node obtains sensor data as to a sensor-detected moving vehicle and uses the sensor data to determine a relative distance and relative direction of the moving vehicle, i.e., a current relative location of the moving vehicle relative to the infrastructure traffic safety node. In process 308, the traffic safety node uses its own absolute location (e.g., expressed in GPS or other GNSS coordinates, etc.) and the current relative location of the moving vehicle to determine a current absolute location (e.g., expressed in GPS or other GNSS coordinates, etc.) of the moving vehicle. In this example, the locations may be expressed in GPS coordinates although other coordinate systems may be used in other exemplary embodiments in which coordinates may be expressed in GNSS coordinates (e.g., BDS coordinates, GLONASS coordinates, etc.), etc.

In process 312, the traffic safety node again obtains sensor data as to the sensor-detected moving vehicle and uses the sensor data to determine another relative distance and another relative direction of the moving vehicle. In process 316, the traffic safety node again uses its own absolute location (e.g., expressed in GPS or other GNSS coordinates, etc.) and the new current relative location of the moving vehicle to determine a new current absolute location (e.g., expressed in GPS or other GNSS coordinates, etc.) of the moving vehicle. In process 320, the traffic safety node uses the absolute locations of the moving vehicle, and time expended between the node's determinations of the absolute locations, to determine a heading and speed of the moving vehicle. The processes 312 through 320 are repeated over time, to substantially continuously predict the trajectory of the moving vehicle.

Although the method 200 is described above as being performed by an infrastructure traffic safety node, in various implementations the method 200 could be performed by a mobile traffic safety node. For example, a DSRC-equipped vehicle, smart phone, or other mobile device may be configured with sensor(s) whereby moving vehicles may be detected. Such a mobile traffic safety node would be equipped with GPS or other coordinate-determining system (e.g., GNSS, BDS, GLONASS, etc.) whereby the mobile traffic safety node could keep track of its own absolute locations as the mobile traffic safety node moves. Such a mobile node could use its own absolute locations, and locations of the moving vehicle relative to the mobile traffic safety node, to determine absolute locations of, and to predict heading and speed of, a detected moving vehicle. It also should be noted that other or additional methods of determining heading and speed of detected moving objects could be implemented in relation to infrastructure traffic safety nodes and/or mobile traffic safety nodes.

Embodiments of the foregoing systems and methods can help DSRC-equipped intersections, infrastructure, vehicles and/or mobile devices take full advantage of DSRC technology, even if not all vehicles approaching an intersection are fully equipped with DSRC technology. Various embodiments can provide an interim arrangement for providing intersection movement assistance that takes vehicles into account that are not DSRC-equipped, until such time as governmental regulation may result in all vehicles on the road having DSRC capability. Various embodiments can be effective to reduce or avoid possible accidents and thus improve safety and accident avoidance at intersections.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-20. (canceled)

21. A traffic safety node comprising:
an interface for wireless communication with other traffic safety nodes;
one or more sensors configured to detect objects in motion; and
a processor and memory configured to:
determine a trajectory of a moving object based on input from the one or more sensors, and
based at least in part on the trajectory, broadcast via the interface a traffic safety message regarding the moving object.

22. The traffic safety node of claim 21, wherein the one or more sensors comprise one or more of the following: radar, a light detection and ranging (LIDAR) device, an ultrasonic sensor, and a camera.

23. The traffic safety node of claim 21, comprised by one or more of the following: infrastructure, a stationary structure, a traffic signal, a traffic sign, a pedestrian way, a road, a street, an alley, a path, and a traffic intersection.

24. The traffic safety node of claim 21, wherein:
the interface comprises a dedicated short-range communications (DSRC) interface; and
the processor and memory are configured to determine whether an object in motion detected by the one or more sensors is a vehicle and/or whether the object in motion detected by the one or more sensors is DSRC-capable.

25. The traffic safety node of claim 21, wherein the interface comprises a dedicated short-range communications (DSRC) interface; and wherein the processor and memory are configured to:
receive, from one or more DSRC-equipped vehicles via the DSRC interface, data as to location, direction of movement, and/or speed of each of the one or more DSRC-equipped vehicles; and
determine whether the moving object is one of the one or more DSRC-equipped vehicles, the determining based on comparing the received data relative to one or more of the following: location of the moving object, direction of movement of the moving object, and speed of the moving object.

26. The traffic safety node of claim 21, wherein:
the interface comprises a dedicated short-range communications (DSRC) interface; and
the traffic safety node is configured to broadcast, via the DSRC interface, traffic safety messages regarding other DSRC-equipped traffic safety nodes.

27. The traffic safety node of claim 21, wherein:
the interface comprises a dedicated short-range communications (DSRC) interface; and
the traffic safety node is configured to receive, via the DSRC interface, traffic safety messages from other DSRC-equipped traffic safety nodes.

28. The traffic safety node of claim 21, comprised by one or more of the following: a vehicle, a smart phone, and a mobile device.

29. A traffic safety node comprising:
a dedicated short-range communications (DSRC) interface for broadcasting traffic safety messages and for receiving traffic safety messages from DSRC-equipped vehicles;
one or more sensors configured to detect objects in motion; and
a processor and memory configured to use input from the one or more sensors to determine a trajectory and speed of a moving object and to determine whether the moving object is a vehicle;
the node further configured to transmit a traffic safety message as to the moving object via the DSRC interface, if the moving object is determined to be a vehicle.

30. The traffic safety node of claim 29, wherein the traffic safety message is in a format receivable by a DSRC-equipped vehicle and/or by DSRC-equipped infrastructure.

31. The traffic safety node of claim 29, comprised by one or more of the following: infrastructure, a traffic signal, a traffic sign, a pedestrian way, a road, a street, an alley, a path, and a traffic intersection.

32. The traffic safety node of claim 29, wherein the one or more sensors comprise one or more of the following: radar, a light detection and ranging (LIDAR) device, an ultrasonic sensor, and a camera.

33. The traffic safety node of claim 29, comprised by one or more of the following: a vehicle, a smart phone, and a mobile device.

34. The traffic safety node of claim 29, wherein the node is stationary or mobile.

35. A method of performing intersection movement assist (IMA), the method comprising:
a traffic safety node receiving, via a DSRC interface, data from one or more DSRC-equipped vehicles;
the traffic safety node using one or more sensors to detect an object in motion, and based on the data received from the one or more DSRC-equipped vehicles, determining whether the detected object in motion is one of the one or more DSRC-equipped vehicles;
based on the determining, the traffic safety node adding the detected object in motion to a list of moving vehicles that includes the one or more DSRC-equipped vehicles; and
the traffic safety node broadcasting, via the DSRC interface, one or more traffic safety messages regarding the moving vehicles including the detected object in motion.

36. The method of claim 35, wherein the data received from the moving vehicles via the DSRC interface includes one or more of the following: vehicle location, direction of vehicle movement, and vehicle speed.

37. The method of claim 35, further comprising, based on the broadcasting by the traffic safety node, one or more DSRC-equipped vehicles broadcasting a traffic safety message regarding the detected object in motion.

38. The method of claim 35, wherein determining whether the detected object in motion is one of the one or more DSRC-equipped vehicles comprises using data from the one or more sensors to compare at least a location of the detected object in motion with one or more DSRC-equipped vehicle locations.

39. The method of claim 35, performed at a traffic intersection.

40. The method of claim 35, performed by a stationary or mobile traffic safety node.
